(19) United States
(12) Patent Application Publication
(10) Pub. No.: US 2006/0056315 A1
(43) Pub. Date: Mar. 16, 2006

(54) Remote configuration interface

(75) Inventors: Andreas Oman, Bagarmossen (SE); Magnus Lundstrom, Johanneshov (SE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: PacketFront Sweden AB

(21) Appl. No.: 11/035,688

(22) Filed: Jan. 13, 2005

Related U.S. Application Data
(60) Provisional application No. 60/607,145, filed on Sep. 2, 2004.

(51) Int. Cl. H04L 12/28

(52) U.S. Cl. 370/254

(57) ABSTRACT

The invention relates to a configuration interface (fa) in an administrators master control device (MD) in a network for at least one of a data- and telecommunication utilizing a protocol for communication between the master control device and connected remote devices (RD) for configuration. It comprises providing the configuration interface (fa) with fields comprising a communication interface (fa1) to be utilized, a remote device (RD) to be configured, and which feature to be configured at the remote device. The interface further comprises storing of configuration information in the configuration interface (fa) regarding the master control device (MD) and the interaction with a remote device (RD), thus abstracting the configuration of remote devices to reside locally in the master control device (MD) in view of the administrator, achieving configuration of two devices from one location overcoming desynchronized configuration between the devices. Moreover, the invention relates to a method, a signal, and an electronic memory for the configuration interface.

### TECHNICAL FIELD

The present invention pertains to a configuration interface in an administrators master/main control device in a network for at least one of a data- and telecommunication utilizing a protocol for communication between the master control device and connected remote devices for configuration. Moreover, the invention relates to a method, a signal, and an electronic memory comprising the configuration interface.

### BACKGROUND ART

Devices that are utilized to communicate in data- and telecommunication networks such as routers, switches, multiplexers have to be synchronized to perform their tasks. Currently this is accomplished by configuration of each device on its own.

An administrator of for instance a broadband network bringing television, radio, telephony, Internet to people's premises having a master control device such as, for example, a router and a remote device being a multiplexer has to configure each of the devices separately. In doing so it is likely that faults appear, and that desynchronized configuration between the master and the remote device do occur. A great number of configurations and re-configurations of a plurality of devices are constantly performed by an administrator when connecting new subscribers or disconnecting former subscribers, implementing new devices, updating of devices and their functions and other tasks, which raises the likelihood of faults to appear.

To solve problems relating to configuration of master and remote devices it would be an advantage to lower the number of separate configurations in a network.

### SUMMARY OF THE INVENTION

It is one aim of the present invention to solve problems related to the configuration of master and remote devices in networks for data- and telecommunication such as for instance broadband networks for cable, fiber, wireless, and the like. Hereby, the present invention sets forth a configuration interface in an administrators master/main control device in a network for at least one of a data- and telecommunication utilizing a protocol for communication between the master control device and connected remote devices for configuration. The invention thus comprises:
providing the configuration interface with data fields comprising the name of the configuration interface to be utilized, a remote device to be configured, and which feature to be configured at the remote device;
configuring any remote device connected in a chain of connected remote devices from the master control device by additionally adding fields for the device to be configured and the feature to be configured at the added device; and
storing configuration information in the configuration interface regarding the master control device and the interaction with a remote device, thus abstracting the configuration of remote devices to reside locally in the master control device in view of the administrator, achieving configuration of at least two devices from one location overcoming desynchronized configuration between the devices.

One embodiment of the present invention provides that the naming is utilized by the protocol for addressing the remote devices.

Another embodiment includes that the chain of remote devices comprises a route from the master control device to an end device at a premise in a broadband network.

A further embodiment comprises that the administrators master control device has a configuration interface for each remote device with a direct connection to the master control device.

Moreover, the present invention sets forth a method providing a configuration interface in an administrators master/main control device in a network for at least one of a data- and telecommunication utilizing a protocol for communication between the master control device and connected remote devices for configuration. The method of the invention comprises the steps of:
creating the configuration interface with data fields comprising the name of the configuration interface to be utilized, a remote device to be configured, and which feature to be configured at the remote device;
configuring any remote device connected in a chain of connected remote devices from the master control device by additionally adding fields for the device to be configured and the feature to be configured at the added device; and
storing configuration information in the configuration interface regarding the master control device and the interaction with a remote device, thus abstracting the configuration of remote devices to reside locally in the master control device in view of the administrator, achieving configuration of at least two devices from one location overcoming desynchronized configuration between the devices.

Further embodiments of the method of the present invention are corresponding to the above interface claims, and attached as independent method claims.

Furthermore, the present invention sets forth a signal carrying information from the configuration interface in accordance with the above configuration interface.

Still further, the present invention sets forth an electronic memory storing the configuration interface in accordance with the above configuration interface.

An embodiment of the electronic memory comprises a CD-disc, DVD-disc, USB-memory, RAM-memory or the like memory.

### BRIEF DESCRIPTION OF THE DRAWINGS

Henceforth reference is had to the attached figures for a better understanding of the present invention with its given examples and embodiments, wherein:

FIG. 1a schematically illustrates a prior art configuration of a master device and a remote device;

FIG. 1b schematically illustrates a configuration of the devices in FIG. 1a in accordance with the present invention;

FIG. 2a schematically illustrates a prior art configuration of a master device and a multiple of remote devices;

FIG. 2b schematically illustrates a configuration of the devices in FIG. 2a in accordance with the present invention;

FIG. 3a schematically illustrates a configuration of a configured master device and remote device, and a customer premises equipment to be configured in accordance with the present invention; and

FIG. 3b schematically illustrates how the master device and a chain of remote devices shown in FIG. 3a are configured in accordance with the present invention.

### DETAILED DESCRIPTION OF PREFERRED EMBODIMENTS

The present invention concerns the addressing of remote interfaces for the configuration or reproduction of information in a conceptual manner. It is up to the specific implementation of the invention how a master/main device and a remote/slave device address each other, how the master device sends configuration information to the remote device, and how information is sent from a remote device to a master device.

Reproduction, remote-link-status, statistics and other information relating to the remote device, is locally depicted at the master device. Hence, it is to be understood that communication between master and remote devices is in duplex, full-duplex or like communication. Everything is accomplished relating to received information with full insight, in spite of one of the devices being a remote device.

Currently, the present invention implements communication between master and remote devices in accordance with the following, which is only one example of a multiple of other possible communication implementations:

iBOS - software run on ASR (Access Switching Router) hardware

|
| - Fast/Gig-Ethernet connection
|

IPD1248 - IP-DSLAM, ADSL

The utilized protocol in the embodiment for the above communication is proprietary (Broadcom® Protocol) and named HMI, depicting one example of a possible protocol.

With the remote interface solution according to the present invention, remote interfaces, i.e., interfaces on remote devices, are abstracted to operate and look like local interfaces. As an example, the Router+DSLAM (Digital Subscriber Line Access Multiplexer) solution is widely utilized in current networks. The DSLAM forwards ATM traffic, Asynchronous Transfer Mode traffic, from DSL lines to an ATM- or VLAN, Virtual Local Area Network, capable router terminating a Layer3 network stack. This requires that an operator has to configure both the Router and the DSLAM separately, which in turn may lead to desynchronized configurations. The following example depicts the prior art configuration in both the DSLAM device and the router:

Example: Pseudo-syntax, prior art, with one configuration in each device:

Configuration in the DSLAM device:
interface line3
atm pvc 0/32 /atm (asynchronous transfer line)/
forward-to VLAN 3
no shutdown
Configuration in the Router device:
interface fastethernet1
accept VLAN 3
interface VLAN 3
arp entry 10.1.1.2 0008.ae01.0203 /arp (address resolution protocol)/
no shutdown

These two portions of configuration need to be kept consistent across both the Router and the DSLAM, creating a hazard for a network operator since each single interface requires configuration in at least two different devices.

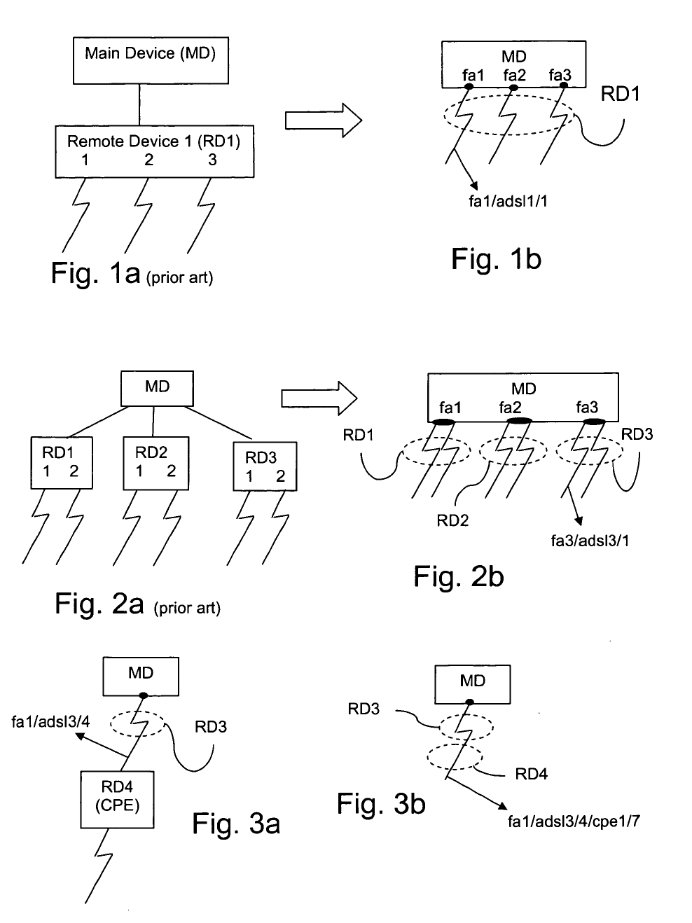

FIG. 1a schematically illustrates a prior art configuration of a master/main device (MD) and a remote device 1 (RD1, for instance ADSL1) where the MD and RD1 devices are separately configured in accordance with prior art. A successful configuration is depicted through flash/lightning symbols which indicate that the signal path or link from the MD through the RD1 is in operation through the accomplished configuration in both devices. Here, in this embodiment RD1 is equipped with three signal paths or links as depicted in its box of FIG. 1 through the numerals 1, 2, and 3.

The present invention solves the problem by configuration of remote Interfaces, so that any remote device, which the existing devices software and/or hardware supports, can be abstracted, making the remote device invisible to the administrator and instead providing remote interfaces as if they were local interfaces in the master/main device MD.

FIG. 1b schematically illustrates a configuration of the devices in FIG. 1a in accordance with the present invention. Hence, the flash symbols now indicate that a successful signal path or link for configuration was made from the MD as if the remote device RD1 was invisible to the administrator of MD through the configuration device fa1/adsl1/1. A configuration interface is schematically illustrated by a black dot. Hence, in accordance with the present invention the configuration interface is named fa1. This means in one embodiment of the present invention that the local fast-Ethernet®-interface No. 1 (fa1) has one remote device adsl1 attached to it, and ads1-line/signal path/link 1 on remote device 1 is thus named in accordance with the following fields fa1/adsl1/1. Fields are divided by slash characters in this specific embodiment, but the present invention is not limited to such characters. Thereby, for all connected devices providing a single point of administration and configuration. This solution requires the master device to be able to control the remote device either by in-band or out-of-band messaging. How this is accomplished is platform dependent and outside the scope of the present invention:

Example: Only one configuration in the master device with the configuration interface in accordance with the present invention:

Configuration in the Router device:
interface fa1
remote unit adsl1 /adsl (asymmetric digital subscriber line)/

| | |
|---|---|
| interface fa1/adsl1/3 | /configuration interface in MD/ |
| atm pvc 0/32 | /atm (asynchronous transfer line)/ |
| arp entry 10.1.1.2 0008.ae01.0203 | /arp (address resolution protocol)/ |
| no shutdown | |

The configuration is now accomplished in the master device MD, which controls the propagation of the configuration to the remote device RD, completely invisible to the administrator. An ARP (Address Resolution Protocol) maps IP-addresses on corresponding Ethernet® addresses, i.e., the ARP recognizes the physical address when only the logical address is known.

FIG. 2a schematically illustrates a prior art configuration of a master device MD and a multiple of remote devices RD1, RD2, RD3 configured separately as in prior art, whereby each remote device has two signal paths/links depicted as 1 and 2 in FIG. 2a.

FIG. 2b schematically illustrates a configuration of the devices in FIG. 2a in accordance with the present invention, for example, as fa3/adsl3/1, thus making up the data fields fast Ethernet interface1/remote device adsl3/link 1 out of two available links. Here, a configuration interface is schematically illustrated by a black ellipse.

In general for instance, the remote interface name “fa1/adsl3/14” means that interface No. 1 has at least three RD devices connected adsl1, adsl2, and adsl3, thus the ads1-line/linkl4 on RD3 is named fa1/adsl3/14. The present invention also supports multiple level configuration of an RD. If an RD is connected at the end of line 14, for example, a customer CPE (Customer Premises Equipment) No. 1 with 8 ports, whereby port No. 5 is the one to be configured, the interface name according to one embodiment of the invention would be fa1/adsl3/14/cpe1/5.

FIG. 3a schematically illustrates a configuration of a configured master device and remote device, and another remote customer premises equipment (CPE) to be configured in accordance with the present invention. The remote interface name fa1/adsl3/4 pin points the line/link 4 connecting the RD4 device.

FIG. 3b schematically illustrates how the master device and a chain of remote devices are configured in accordance with the present invention, being addressed as fa1/adsl3/4/cpe1/7, which means remote interface No. 1, RD3 (adsl3), line/link 4 connecting a CPE with port 7 configured.

Hence, the present invention thus comprises providing the configuration interface with data fields at least comprising the name of the configuration interface to be utilized, a remote device to be configured, and which feature to be configured at the remote device. The invention further provides the configuration of any remote device connected in a chain of connected remote devices from the master control device by additionally adding fields for the device to be configured and the feature to be configured at the added device.

Moreover, the present invention stores configuration information in the configuration interface regarding the master control device and the interaction with a remote device. In this manner abstracting the configuration of remote devices to reside locally in the master control device in view of an administrator, thus achieving configuration of at least two devices from one location overcoming desynchronized configuration between the devices.

The Router+DSLAM topology is an example of the present invention, which generally is generic and operates on any supported future master or remote device.

A person skilled in the art of the present invention appreciates that further embodiments of the present invention then those explicitly disclosed herein will be apparent from the attached set of claims.

What is claimed is:

1. A configuration interface in an administrators master control device in a network for at least one of a data- and telecommunication utilizing a protocol for communication between said master control device and connected remote devices for configuration, comprising:
providing said configuration interface with data fields comprising the name of configuration interface to be utilized, a remote device to be configured, and which feature to be configured at the remote device;
configuring any remote device connected in a chain of connected remote devices from said master control device by additionally adding fields for the device to be configured and the feature to be configured at the added device; and
storing configuration information in said configuration interface regarding the master control device and the interaction with a remote device, thus abstracting the configuration of remote devices to reside locally in the master control device in view of the administrator, achieving configuration of at least two devices from one location overcoming desynchronized configuration between the devices.

2. A configuration interface according to claim 1, wherein

3. A configuration interface according to claim 1, wherein said chain of remote devices comprises a route from said master control device to an end device at a premise in a broadband network.

4. A configuration interface according to claim 1, wherein said administrators master control device has a configuration interface for each remote device with a direct connection to said master control device.

5. A method providing a configuration interface in an administrators master control device in a network for at least one of a data- and telecommunication utilizing a protocol for communication between said master control device and connected remote devices for configuration, comprising the steps of:
creating said configuration interface with data fields comprising the name of the configuration interface to be utilized, a remote device to be configured, and which feature to be configured at the remote device;
configuring any remote device connected in a chain of connected remote devices from said master control device by additionally adding fields for the device to be configured and the feature to be configured at the added device; and
storing configuration information in said configuration interface regarding the master control device and the interaction with a remote device, thus abstracting the administrator, achieving configuration of at least two devices from one location overcoming desynchronized configuration between the devices.

6. A method according to claim 5, wherein said fields are utilized by said protocol for addressing said remote devices.

7. A method according to claim 5, wherein said chain of remote devices comprises a route from said master control device to an end device at a premise in a broadband network.

8. A method according to claim 7, wherein each remote device configuration interface is utilized configuring any remote device connected in a chain of connected remote devices from said master control device by additionally adding fields for the device to be configured and the feature to be configured at the added device.

9. A signal carrying information from the configuration interface according to claim 1.

10. An electronic memory storing the configuration interface according to claim 1.

11. A configuration interface according to claim 10, wherein said electronic memory is a CD-disc, DVD-disc, USB-memory, RAM-memory or the like memory.
